(19) United States
(12) Patent Application Publication
(10) Pub. No.: US 2009/0028780 A1
(43) Pub. Date: Jan. 29, 2009

(54) METHOD AND DEVICE FOR PRODUCING CHLORINE BY GAS PHASE OXIDATION IN A COOL WALL REACTOR

(75) Inventors: Stephan Schubert, Leverkusen (DE); Ralph Schellen, Dormagen (DE); Leslaw Mleczko, Dormagen (DE)

Correspondence Address: NORRIS, MCLAUGHLIN & MARCUS, P.A., 875 THIRD AVE, 18TH FLOOR, NEW YORK, NY, 10022, US

(73) Assignee: BAYER TECHNOLOGY SERVICES GMBH, LEVERKUSEN (DE)

(21) Appl. No.: 12/282,528

(22) PCT Filed: Mar. 2, 2007
(86) PCT No.: PCT/EP2007/001789

§ 371 Date: Sep. 11, 2008

(30) Foreign Application Priority Data
Mar. 14, 2006 (DE) 10 2006 011 496.5

(51) Int. Cl. C01B 7/01

(52) U.S. Cl. 423/502; 422/222

(57) ABSTRACT

The present invention relates to a process and an apparatus for preparing chlorine by gas-phase oxidation of hydrogen chloride by means of an oxygen-containing gas stream, wherein the catalyst required for the reaction is applied to the interior wall of one or more externally cooled reaction channels.

The present invention relates to a process and an apparatus for preparing chlorine by gas-phase oxidation of hydrogen chloride by means of an oxygen-containing gas stream in the presence of a catalyst applied to the interior wall of an externally cooled reaction channel.

The process of catalytic oxidation of hydrogen chloride by means of oxygen in an exothermic equilibrium reaction which was developed by Deacon in 1868 was the beginning of industrial chlorine chemistry. However, chloralkali electrolysis pushed the Deacon process far into the background. Virtually the entire production of chlorine was carried out by electrolysis of aqueous sodium chloride solutions. However, the attractiveness of the Deacon process has been increasing again in recent times since the worldwide demand for chlorine is increasing more quickly than the demand for sodium hydroxide. The process for preparing chlorine by oxidation of hydrogen chloride can provide assistance in this development since it is decoupled from sodium hydroxide production. Furthermore, the starting material hydrogen chloride is readily available; it is obtained in large quantities as coproduct in, for example, phosgenation reactions as in isocyanate production.

The catalysts initially used for the Deacon process, for instance supported catalysts containing CuCl₂ as active composition had only low activities. Although the activity could be increased by increasing the reaction temperature, this had the disadvantage that the volatility of the active components at elevated temperatures led to rapid deactivation of the catalyst. In addition, the oxidation of hydrogen chloride to chlorine is an equilibrium reaction. The position of the equilibrium is shifted away from the desired end product as the temperature increases. It is therefore advantageous to use catalysts which have a very high activity and allow the reaction to proceed at a relatively low temperature. Known high-activity catalysts are based on ruthenium. DE-A 197 48 299 describes supported catalysts containing ruthenium oxide or ruthenium mixed oxide as active composition. Here, the ruthenium oxide content is from 0.1 to 20% by weight and the mean particle diameter of ruthenium oxide is from 1.0 nm to 10.0 nm. The reaction is carried out at a temperature of from 90° C. to 150° C. Further supported catalysts based on ruthenium are known from DE-A 197 34 412: ruthenium chloride catalysts containing at least one of the compounds titanium oxide or zirconium oxide, ruthenium-carbonyl complexes, ruthenium salts of inorganic acids, ruthenium-nitrosyl complexes, ruthenium-amine complexes, ruthenium complexes of organic amines or ruthenium acetylacetonate complexes. The reaction is carried out at a temperature of from 100° C. to 500° C., preferably from 200° C. to 380° C. In the two patent applications DE-A 197 48 299 and DE-A 197 34 412, the catalyst is used in a fixed bed or in a moving bed. Air or pure oxygen is used as oxygen starting material.

A known industrial problem in the gas-phase oxidation of hydrogen chloride to chlorine is the formation of hot spots, i.e. regions of local overheating, in the fixed-bed catalyst. These lead to an unfavourable shift in the reaction equilibrium in the direction of the starting materials, resulting in a corresponding deterioration in the yield. A further consequence is deactivation of the catalyst right up to destruction of the catalyst material and catalyst tube material. As a consequence, costly changes of catalyst material have to be carried out regularly. Apart from the actual catalyst costs, this incurs considerable costs due to the loss of production associated with the downtime. Various proposals for the design, cooling and activity of the catalyst bed have been proposed in order to solve these problems.

To avoid the hot spots, the high-activity catalysts are used in a fluidized-bed process. In such a process, a technical problem is the undesirable formation of large gas bubbles. EP-A 331 465 describes a fluidized-bed process for the Deacon process in which an attempt is made to suppress the undesirable formation of hot spots by means of perforated plates. The conversions achieved in this process were a maximum of only 83% and the temperature in the reactor was from about 360° C. to 400° C. However, owing to the high dynamic stresses occurring in fluidized-bed reactors and the high aggressiveness of the starting materials, the reactors required for this process are technically complicated and costly. Furthermore, unreacted hydrogen chloride and also abraded material have to be discharged from the fluidized bed and worked up appropriately at great expense. Likewise, catalyst which has been lost by discharge from the reactor has to be replaced. The possibility of in situ replacement of the catalyst is advantageous in principle. WO-A1-1990015017 (EP-B 474 763) also describes a fluidized-bed process in which the abovementioned disadvantages occur.

U.S. Pat. No. 2,577,808 describes a multistage moving-bed process. The catalyst bed passes through a preheating or cooling zone and then through a chlorination zone in which the hydrogen chloride is converted by means of the catalyst into chlorinated catalyst compounds. In the subsequent oxidation zone, the chlorinated catalyst compounds react further with oxygen to liberate chlorine. The catalyst bed is recirculated pneumatically to the first zone. Even in this moving-bed process, undesirable attrition cannot be avoided and, owing to the high mechanical stress on the reactor, corrosion cannot be prevented entirely in the presence of the aggressive starting materials. Furthermore, the conversion can be reduced by backmixing effects and in order to improve the yield, the individual zones should be operated at different temperatures, which further increases the costs of this process. Likewise, there is a risk of hydrogen chloride or chlorine or water being carried over into the other reaction zones. A further disadvantage is that this process produces process gases admixed with chlorine which have to be subjected to appropriate, costly work-up procedures. The in-principle possibility of in situ catalyst replacement is an advantage of the catalyst flow diagram.

WO-A1-91/06505 (EP-B 500 728) describes a two-stage process for preparing chlorine from HCl. The chlorination is carried out at relatively low temperatures of from 25° C. to 250° C. and the dechlorination is carried out at temperatures of at least 300° C. Continual heating and cooling of a large amount of solids is therefore required. This requirement also restricts the opportunities for designing a corrosion-resistant reactor.

In U.S. Pat. No. 2,204,733, the Deacon process is carried out in a fixed-bed reactor. However, the highly exothermic nature of the reaction produces a large local temperature increase in the fixed catalyst bed, with the disadvantages described. As a starting point for a solution, an attempt is made to counter these difficulties by flow reversal within the fixed bed. However, the catalysts used have an appreciable volatility at the temperatures occurring here because of their vapour pressure (some components can be present as an aggressive melt in places having a greatly increased temperature), so that barely controllable concentration changes of the catalyst occur within the fixed bed. These heterogeneities further reduce the conversion. Furthermore, the fixed catalyst bed can become blocked by deposited catalyst.

To reduce or prevent the formation of hot spots in the fixed catalyst bed, WO 2004/052776 proposes measures for improving heat transfer in externally cooled reaction tubes. Essentially, the heat transfer on the outside of the reaction tubes is improved by means of various structural modifications of the coolant-conveying shell volume of the shell-and-tube reactor described. However, the reaction-side heat transfer coefficient generally limits the heat transfer and is thus critical for the formation of hot spots. Measures which serve only to improve the heat transfer coefficient of the cooling medium are therefore usually not suitable for significantly reducing the formation of hot spots.

The R&D report “Sumitomo Kagaku”, Vol. 2004-I, proposes the use of a fixed-bed catalyst comprising ruthenium oxide on titanium oxide as support. Apart from the high catalyst activity, the good thermal conductivity of the catalyst system is said to be an advantage. However, this property is hardly sufficient to effectively avoid hot spots in the shell-and-tube reactor described, since the thermal conductivity of the bed remains low even in the case of a high thermal conductivity within the catalyst pellets. Thus, the heat of reaction produced in the catalyst pellets mostly has to be transported away via the reaction gas and thus via two limiting interfaces to the shell of the reaction tube.

EP-A1-1 170 250 has proposed using catalyst charges which have different activities in different regions of the cooled catalyst tubes. As a result, the progress of the reaction in the region of possible hot spots is slowed to such an extent that the heat of reaction evolved can be removed via the wall of the catalyst tubes. A similar result is said to be achieved by targeted dilution of the catalyst bed with inert material. A disadvantage of these solutions is that two or more catalyst systems have to be developed and used in the catalyst tubes or that the reactor capacity is decreased by use of inert material.

DE-A1-10 311 865 describes a process for preparing isocyanates in a plant comprising building blocks of microtechnology. The preparation of chlorine by a Deacon process is presented as a process step. However, the proposed reaction in a fixed-bed reactor has the above-described disadvantage of an unsatisfactory reaction-side heat transfer coefficient even in the desired micro scale. The avoidance of hot spots cannot be ensured reliably in this way. Moreover, the preparation of up to 10 kg/h of isocyanate mentioned corresponds to a production of about 5 kg/h of chlorine and would only be of interest for decentralized supply to small manufacturers of downstream products. Economical production in plants having economy-of-scale takes place in other orders of magnitude.

It was therefore an object of the invention to provide a process for preparing chlorine by catalytic oxidation of hydrogen chloride, in which the high-activity catalyst is distributed as homogeneously as possible in the reactor and the formation of hot spots during the course of the reaction is very small.

In the present invention, the catalyst required for the reaction is applied to the interior wall of one or more externally cooled reaction channels.

The object of the invention is surprisingly achieved by the formation of hot spots by the catalyst applied to the interior wall being able to be reduced effectively by means of radial cooling of the reactor wall during the process and by the operating life and selectivity of the catalyst being able to be improved thereby.

The cooling medium which is in thermal contact with the reaction channel is preferably likewise conveyed in at least two cooling medium channels which are essentially parallel to one another and run in cocurrent, in countercurrent or in cross-current relative to the main flow direction in the reaction channel.

Cooling media used are salt melts, steam, organic compounds or metal melts, preferably salt melts, steam or heat transfer fluids, particularly preferably a mixture of potassium nitrate, sodium nitrite and sodium nitrate, dibenzyltoluene or a mixture of diphenyl oxide and biphenyl.

In a preferred embodiment of the process, the cooling medium or media is/are conveyed in cross-current to the main flow direction in the reaction channel and is/are divided over at least two essentially parallel cooling medium channels. The cooling medium channels can have different materials properties, flow velocities, throughputs or temperatures in order to provide at least two zones of differing temperature in the reaction channel, most preferably temperatures which decrease in the main flow direction in the reaction channel. This makes it possible to combine the avoidance of hot spots at a comparatively high reaction rate at the beginning of the reaction channel with a high conversion due to the favourable equilibrium at the end of the reaction channel.

The catalyst is applied in a layer having a thickness of from 5 to 1000 μm, preferably from 10 to 500 μm, particularly preferably from 20 μm to 200 μm, to the interior wall of the reaction channel. Application can in principle be effected by any known technology; the catalyst is preferably applied as washcoat to the interior wall of the reaction channel.

The catalyst is a supported catalyst whose catalyst component consists entirely of or partly comprises copper, copper chloride, copper oxide, potassium chloride, sodium chloride, chromium oxide, cerium, ruthenium, ruthenium oxide, ruthenium chloride, rhodium, rhodium oxide, platinum, elements of group 8 (Mendelejew, Zeitschrift für Chemie 12, 405-6, 1869) or a mixture or compound of the substances mentioned. The catalyst component preferably consists entirely of or partly comprises ruthenium derivatives and particularly preferably ruthenium oxide. The support component consists entirely of or partly comprises titanium oxide, aluminium oxide, zirconium oxide, vanadium oxide, chromium oxide, silicon oxide, diatomaceous earth or a mixture or compound of the substances mentioned; preferred support components are titanium oxide and titanium mixed oxide.

The catalyst is a supported catalyst whose catalyst component consists entirely of or partly comprises copper, copper chloride, copper oxide, potassium chloride, sodium chloride, chromium oxide, cerium, ruthenium, ruthenium oxide, ruthenium chloride, ruthenium oxide chloride, rhodium, rhodium oxide, platinum, elements of group 8 (Mendelejew, Zeitschrift für Chemie 12, 405-6, 1869) or a mixture or compound of the substances mentioned. The catalyst component preferably consists entirely of or partly comprises ruthenium derivatives and particularly preferably ruthenium oxide. The support component consists entirely of or partly comprises titanium oxide, aluminium oxide, zirconium oxide, vanadium oxide, chromium oxide, silicon oxide, tin oxide, diatomaceous earth or a mixture or compound of the substances mentioned; preferred support components are tin oxide, titanium oxide and titanium mixed oxide.

Preference is given to operating at least two reaction channels under identical reaction conditions.

In the process of the invention, it is possible to produce from 0.1 g/h to 10 g/h of chlorine, preferably from 0.3 g/h to 3 g/h of chlorine, per 1 g of catalyst applied to the interior wall of the reaction tube.

The starting material for the process of the invention is hydrogen chloride which is produced and taken over as, for example, coproduct from the phosgenation of a diamine to a diisocyanate or the gas-phosgenation of phenol to diphenyl carbonate.

The chlorine produced can be used, for example, for preparing phosgene.

The amount of chlorine produced by the process of the invention is in the range from 20 kg/h to 20 t/h, preferably from 100 kg/h to 10 t/h, particularly preferably from 1 t/h to 5 t/h.

A suitable reactor for the process is, without being restricted thereto, the following reactor according to the invention, which is itself likewise subject matter of the present patent application.

The reactor for preparing chlorine by the process of the invention comprises one or more externally cooled reaction channels to whose interior walls the catalyst required for the reaction has been applied.

The proportion of the total volume of the apparatus made up by the catalyst volume is usually from 1% to 50%, preferably from 5% to 35%, particularly preferably from 10% to 25%.

The proportion of the total volume of the apparatus made up by the catalyst volume is usually from 0.2 to 50%, preferably from 0.2% to 35%, very particularly preferably from 0.2% to 25%.

The reaction channels have a round or rectangular cross-sectional area having a hydraulic diameter defined as the ratio of four times the internal cross-sectional area to the internal circumference of from 0.05 mm to 100 mm, preferably from 0.1 mm to 10 mm, particularly preferably from 0.5 mm to 2 mm, and a length of from 0.02 m to 5.0 m, preferably from 0.1 m to 1.0 m, particularly preferably from 0.2 to 0.7 m (in Example 2, L=0.25 m).

The temperature in the reaction channels is maintained at a very constant temperature by means of the cooling medium channels through which cooling medium flows. When one temperature zone is employed, this temperature is from 200° C. to 450° C., preferably from 250° C. to 370° C., particularly preferably from 320° C. to 330° C. When a plurality of temperature zones are used, the temperature variation in the reaction channel is from 5 K to 200 K, preferably from 20 K to 150 K, particularly preferably from 50 K to 100 K.

The temperature in the reaction channel can be monitored by means of sensors during the process and the flow rate or temperature of the cooling medium in the cooling medium channels can be adjusted if required. The sensors can be located either in the region of the cooling medium or in the region of the reaction channel, preferably at the inlet and outlet for the cooling medium.

The process can be carried out continuously or batchwise, preferably continuously.

Hydrogen chloride gas flows together with oxygen at an absolute pressure of from 1 bar to 50 bar, preferably from 1 bar to 5 bar, particularly preferably from 2 bar to 3 bar, into the reaction channel. The specific volume flows are from 1 to 1000 standard 1 of HCl/min/kg of catalyst or from 0.2 to 500 standard 1 of oxygen/min/kg of catalyst, preferably from 10 to 100 standard 1 of HCl/min/kg of catalyst or from 2 to 50 standard 1 of oxygen/min/kg of catalyst.

The conversion of hydrogen chloride into chlorine at the outlet of the reaction channel is from 30% to 99%.

Preference is given to at least two, preferably from 20 000 to 200 000 000, reaction channels, preferably of the same geometry, being arranged in parallel. In a particular embodiment, the reaction channels are located in one or more plates for reaction channels, so that these plates are in thermal contact with at least one set of parallel cooling medium channels which are preferably also located in one or more plates. Here, preference is given to at least two, particularly preferably from 200 to 20 000, parallel reaction channels being present in each plate (FIG. 1). Furthermore, preference is given to at least two, particularly preferably from 100 to 10 000, plates comprising reaction channels alternating with a comparable number of parallel plates comprising cooling medium channels in a vertical stack (FIGS. 2 and 3).

In a particular embodiment of the reactor, the superposed, alternating plates comprising reaction channels and the cooling medium channels are divided into individual exchangeable modules (FIGS. 4 and 5). In a particular embodiment of the process, at least two modules of superposed planes of reaction channels and cooling medium channels are operated in parallel under identical reaction conditions, so that an individual module can, as a result of the mode of construction, be removed from the process, added to the process or replaced without operation of the other modules being interrupted.

In a particular embodiment of the apparatus, the reaction channel is configured as a reaction tube so that the reaction is carried out in a shell-and-tube reactor, with cooling of the reaction tubes being ensured by appropriate flow of a cooling medium on the shell side of the reactor.

A stainless steel, e.g. 1.4571 or 1.4828, nickel, i.e. 2.4068, or a nickel-based alloy, e.g. 2.4610, 2.4856 or 2.4617, is preferably used as material of construction for the reactor of the invention, with the reactor being able to be manufactured entirely or partly of this.

Compared to the above-described prior art, the use of a modular reactor concept in which the cooled reactor comprises a plurality of modules operated in parallel is advantageous when immobilized catalysts are used. This construction makes it possible for individual modules to be replaced when the catalyst needs to be changed so that production downtime is significantly reduced. As a result of the remaining reactor modules being operated at a higher loading for a short time, production downtime may also be able to partly or completely avoided. Owing to the ease of handling, the modular construction of a microreactor is a particularly useful and therefore preferred variant.

To reduce the pressure drop and to improve heat transfer, the immobilized catalyst material is, in the process of the invention, not configured as a fixed bed but is instead applied as a thin layer to the interior wall of the cooled reaction channel. When this concept was studied by simulation, it was surprisingly found that the formation of hot spots in the preparation of chlorine from hydrogen chloride can be effectively prevented. It was found that, owing to the low thickness of the catalyst layer applied to the interior wall and the good heat transfer between the applied catalyst and the channel wall cooled by means of an external cooling medium, the degree of heat removal achieved is so high that the heat of reaction liberated by the reaction can be removed immediately and virtually completely from the reaction channel and virtually isothermal reaction conditions can be achieved. Furthermore, the use of a microreactor increases the volume-specific heat transfer area, so that the heat removal achieved is increased further.

### EXAMPLES

The following examples illustrate the present invention without restricting it to them:

### Example 1

In EP 1170 250 A1, a catalyst suitable for preparing chlorine by gas-phase oxidation of hydrogen chloride is introduced into an Ni reactor tube cooled by a salt melt in a jacket. The reactor tube has an internal diameter of 18 mm and a tubular sheath having an external diameter of 5 mm for measuring the temperature is located in the middle of the tube. The catalyst bed comprises two reaction zones, with the activity of the first reaction zone being 1.6·10⁻⁴ mol of HCl/ml of reaction zone and thus about half the activity in the second reaction zone which is reported as 3.1·10⁻⁴ mol of HCl/ml of reaction zone. The length of the first reaction zone is 0.280 m, and that of the second reaction zone is 0.235 m. The temperature of the salt melt is 326° C.

Hydrogen chloride gas (hydrogen chloride content is at least 99% by volume) is introduced together with oxygen (oxygen content is at least 99% by volume) at a volume flow of 6.1 standard l/min and 3.05 standard l/min, respectively, into the reactor from the top, from which a superficial velocity of 0.65 m/s can be calculated.

In the first reaction zone, the entry temperature is 332° C., the exit temperature is 335° C. and the temperature of the hot spot is 347° C. In the second reaction zone, the entry temperature is 335° C., the exit temperature is 338° C. and the temperature of the hot spot is 344° C. The conversion of hydrogen chloride to chlorine at the reactor outlet is 30.6%.

A mathematical simulation model which models the cooled reactor tube and the experimental conditions of Example 1 shows that the preparation of chlorine by gas-phase oxidation of hydrogen chloride according to the reaction procedure described in Example 1 can be described by the following kinetic equation:

$$R = \frac{{k}_{10} \cdot {e}^{\frac{- {E}_{A}}{R \cdot T}} \cdot {p}_{HCl} \cdot {p}_{{O}_{2}}^{0.5}}{1 + {k}_{2} \cdot {p}_{{Cl}_{2}}} \cdot ( 1 - \frac{{Q}_{R}}{{K}_{p}} )$$

Here, Q_{R} is the reaction quotient and Kₚ is the equilibrium constant of the reaction. For the activity of 3.1·10⁻⁴ mol of HCl/ml of reaction zone reported in Example 1, the values k₁₀=0.21 mol/(kg·s·Pa^{1.5}), E_{A}=99.8 kJ/mol and k₂=1.29 10^{-4 Pa·1} were found.

The experimental results described in Example 1 can be reproduced with an accuracy of ±1% by the mathematical simulation model. The calculated entry temperature into the first reaction zone is 333° C., the calculated exit temperature is 338° C. and the calculated temperature of the hot spot is 345° C. The calculated entry temperature into the second reaction zone is 338° C., the calculated exit temperature is 337° C. and the calculated temperature of the hot spot is 345° C. The calculated conversion is 30.6%.

### Example 2

A reaction channel in which, according to the invention, the catalyst suitable for the preparation of chlorine by gas-phase oxidation of hydrogen chloride is applied to the interior wall of the reaction channel is modelled by a corresponding mathematical simulation model. Here, the reaction of hydrogen chloride to chlorine is described by the following kinetic equation:

$$R = \frac{{k}_{10} \cdot {e}^{\frac{- {E}_{A}}{R \cdot T}} \cdot {p}_{HCl} \cdot {p}_{{O}_{2}}^{0.5}}{1 + {k}_{2} \cdot {p}_{{Cl}_{2}}} \cdot ( 1 - \frac{{Q}_{R}}{{K}_{p}} )$$

where k₁₀=0.21 mol/(kg·s·Pa^{1.5}), E_{A}=99.8 kJ/mol and k₂=1.29·10^{-4 Pa·1}. Q_{R} is the reaction quotient and the Kₚ is the equilibrium constant of the reaction.

The reaction channel has a height of 500 μm, a width of 500 μm and a length of 0.25 m. The thickness of the catalyst layer on the interior wall of the reaction channel which is cooled externally by means of heat transfer fluid (326° C.) is 50 μm. Hydrogen chloride flows together with oxygen at a pressure of 2.2 bar into the reaction channel, and the specific volume flows are 52.5 standard 1 of HCl/min/kg of catalyst and 26.3 standard 1 of oxygen/min/kg of catalyst. The entry temperature is 326.1° C., the exit temperature is 326.1° C. and the maximum temperature is 326.6° C. The conversion of hydrogen chloride into chlorine at the outlet of the reaction channel is 45.5%.

The apparatus of the invention and the corresponding process accordingly display a surprising superiority to the known apparatuses and processes, namely no hot spots and an about 50% higher conversion.

### Example 3

The preparation of chlorine by gas-phase oxidation of hydrogen chloride by means of oxygen in the presence of a ruthenium-containing catalyst was carried out on a laboratory scale in an experimental reactor having 93 reaction channels arranged parallel to one another in a plane. The channels have a square cross section having an edge length of 0.5 mm and a length of 130 mm. A gas distributor at the starting material inlet into the reactor ensures uniform distribution of the reactants over the reaction channels.

Structurally, the individual reaction channels are configured as two half channels having a rectangular cross section of 0.25 mm×0.5 mm each. Each 93 half channels are arranged on a reactor plate made of the steel 1.4571. Two stacked and sealed reactor plates form the 93 reaction channels. The reactor plates are heated on the rear side to the desired reaction temperature by means of a heat transfer fluid conveyed in countercurrent.

The half channels of one of the two reactor plates were coated with about 2.8 g of tin oxide as catalyst support. A ruthenium chloride solution was applied mechanically in a number of layers to this and dried. After application of all layers, the catalyst system was calcined at 250° C. Altogether, the interior walls of the 93 half channels were coated in this way with a catalyst component (i.e. a catalytic component) comprising about 0.1 g of ruthenium chloride. The layer thickness was from 15 μm to 55 μm. The proportion of the total volume of the apparatus made up by the catalyst volume was about 0.3%.

Hydrogen chloride and oxygen were passed through the reaction channels at atmospheric pressure and a temperature of the cooling medium dibenzyltoluene of 275° C., 300° C., 330° C. and 347° C. For each temperature, a feed mixture of hydrogen chloride to oxygen (in standard l/min/kg of catalyst) of 17:17, 34:17 and 34:34 was set.

The catalyst activities achieved in the experiments carried out are as follows:

| T | V_{HCl} | V_{O2} | Activity |
|---|---|---|---|
| [° C.] | [standard l/min/kg_{cat.}] | [standard l/min/kg_{cat.}] | [kg_{Cl2}/h/kg_{cat.}] |
| 275 | 17 | 17 | 0.018 |
| 275 | 34 | 17 | 0.029 |
| 275 | 34 | 34 | 0.037 |
| 300 | 17 | 17 | 0.040 |
| 300 | 34 | 17 | 0.041 |
| 300 | 34 | 34 | 0.066 |
| 330 | 17 | 17 | 0.079 |
| 330 | 34 | 17 | 0.122 |
| 330 | 34 | 34 | 0.095 |
| 347 | 17 | 17 | 0.185 |
| 347 | 34 | 17 | 0.129 |
| 347 | 34 | 34 | 0.143 |

### FIGURES

Examples of the subject matter of the invention are depicted in FIG. 1 to 5, without the invention being restricted thereto.

FIG. 1: Structured plate with parallel reaction channels (1).

FIG. 2: Cross section of a module made up of alternating, superposed structured plates for reaction channels (1) and cooling medium channels (2) in cocurrent or countercurrent.

FIG. 3: Module made up of alternating, superposed structured plates for reaction channels (1) and cooling medium channels (2) in cross-current.

FIG. 4: Arrangement of exchangeable modules operated in parallel.

FIG. 5: Connections of the reaction channels and the cooling medium channels of two modules which operate in parallel and can be replaced without interrupting the operation of the other module.

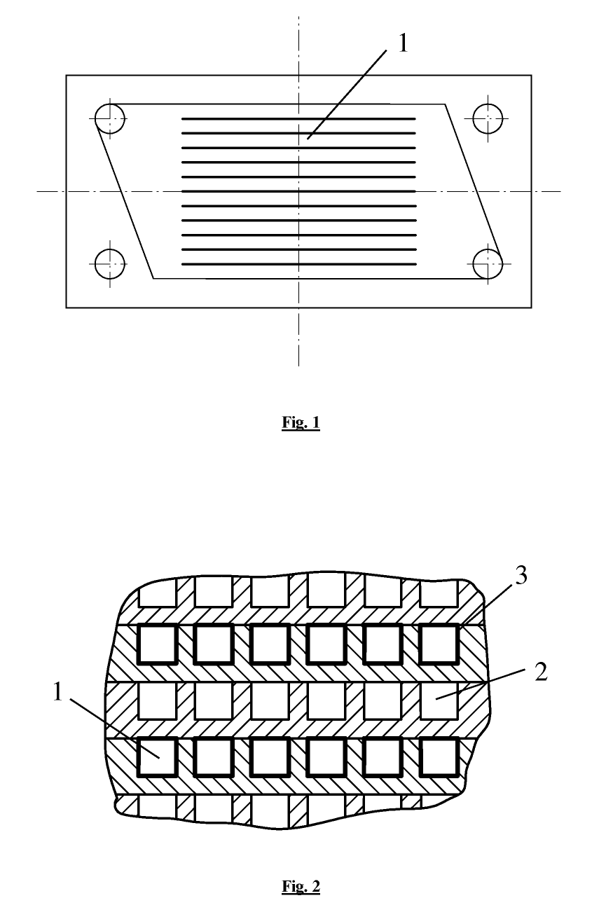

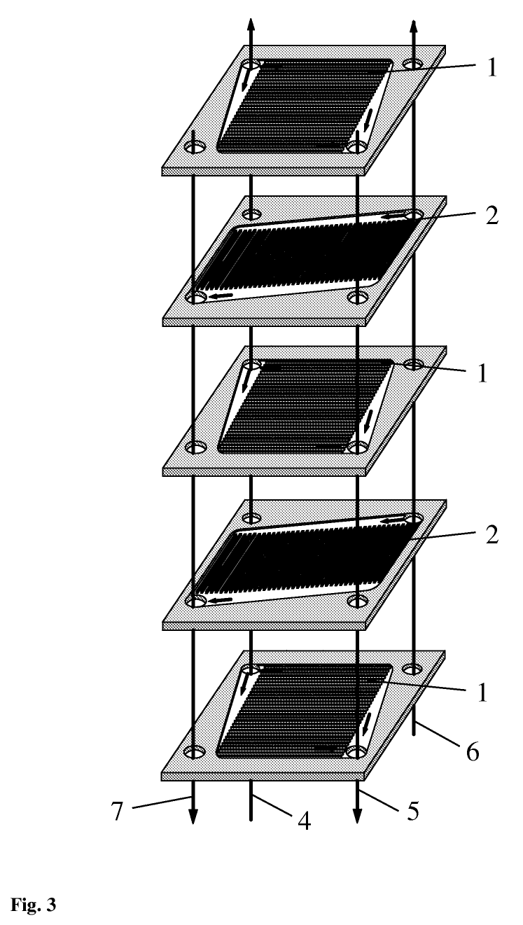

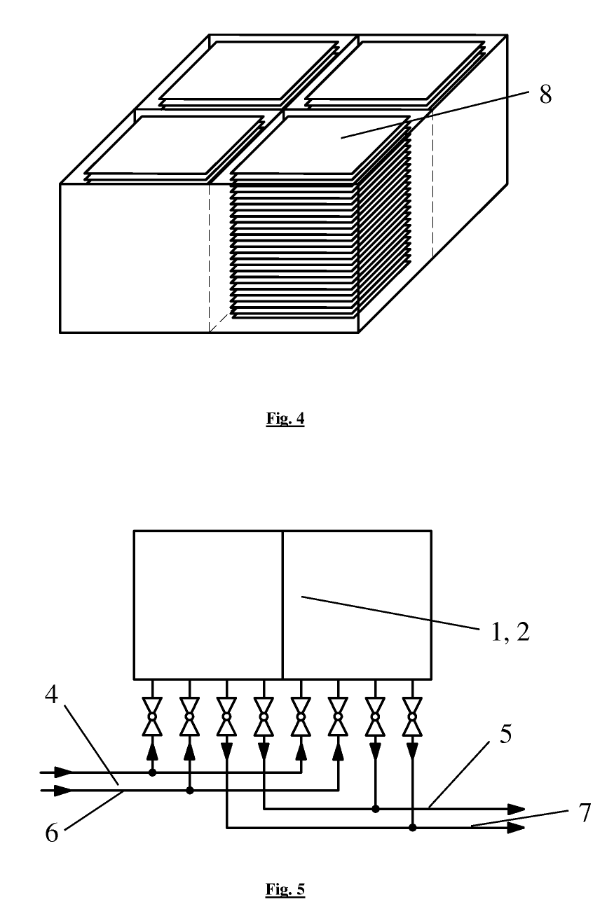

### REFERENCE NUMERALS

1—Reaction channels
2—Cooling medium channels
3—Catalyst layer
4—Feed into the reaction channels
5—Discharge from the reaction channels
6—Feed into the cooling medium channels
7—Discharge from the cooling medium channels
8—End plate

1. Process for preparing chlorine by gas-phase oxidation of hydrogen chloride with an oxygen-containing gas stream in a reactor comprising one or more externally cooled reaction channels, wherein the catalyst required for the reaction is applied to the interior wall of one or more of said externally cooled reaction channels.

2. Process according to claim 1, wherein a cooling medium is in thermal contact with the reaction channel and said cooling medium is conveyed in cocurrent, in countercurrent or in cross-current to the flow direction of the gas stream in the reaction channel.

3. Process according to claim 2, wherein the cooling medium is divided over at least two essentially parallel flow channels.

4. Process according to claim 2, wherein one or more cooling media are conveyed in cross-current to the flow direction of the gas stream in the reaction channels and are divided over at least two essentially parallel cooling medium channels, and the cooling medium channels have different materials properties, flow velocities, throughputs or temperatures.

5. Process according to claim 1, wherein the catalyst applied to the interior wall of the reaction channel has a layer thickness of from 5 μm to 1000 μm.

6. Apparatus for carrying out chemical reactions, comprising one or more externally cooled reaction channels to whose interior walls a catalyst required for the reaction is applied.

7. Apparatus according to claim 6, wherein the reaction channel has a round or rectangular cross-sectional area and a hydraulic diameter of from 0.05 mm to 100 mm.

8. Apparatus according to claim 6, wherein at least two reaction channels having the same geometry are arranged in parallel.

9. Apparatus according to claim 6, wherein the reaction channels are arranged in a plane and this plane is in thermal contact with at least one parallel space conveying cooling medium.

10. Apparatus according to claim 6, wherein the at least two planes of reaction channels alternating with spaces conveying cooling medium are arranged parallel to one another above one another.

11. Apparatus according to claim 6, wherein the proportion of the total volume of the apparatus made up by the catalyst volume is from 0.2 to 50%.

12. Apparatus according to claim 6, wherein the proportion of the total volume of the apparatus made up by the catalyst volume is from 1 to 50%.
